(19) United States
(12) Patent Application Publication
(10) Pub. No.: US 2026/0224336 A1
(43) Pub. Date: Aug. 6, 2026

(54) BASE, SCREW AND INTERCHANGEABLE INTERMEDIARY PIECE FOR SECURING A DENTAL PROSTHESIS TO A DENTAL IMPLANT AND PROSTHETIC COMPONENT FOR SECURING A DENTAL PROSTHESIS TO A DENTAL IMPLANT

(71) Applicant: M3 HEALTH INDÚSTRIA E COMÉRCIO DE PRODUTOS MÉDICOS, ODONTOLÓGICOS E CORRELATOS S.A., Jundiaí (BR)

(72) Inventors: Alberto BLAY, São Paulo (BR); Alex Araújo NUCINI, Santa Rosa de Viterbo (BR); André DE PALMA TEGON, São Paulo (BR); Elaine YOSHIKO MATSUBARA, São Paulo (BR); Luiz Antônio SASKA JUNIOR, Araraquara (BR); Sybele SASKA SPECIAN, Santana de Parnaiba (BR)

(21) Appl. No.: 19/111,154

(22) PCT Filed: Sep. 11, 2023
(86) PCT No.: PCT/BR2023/050300

§ 371 Date: Mar. 6, 2026

(30) Foreign Application Priority Data
Sep. 12, 2022 (BR) 1020220182337

(51) Int. Cl. A61C 8/00

(52) U.S. Cl. CPC A61C 8/0074; A61C 8/0056; A61C 8/006; A61C 8/0068

(57) ABSTRACT

The present invention relates to a base system for fixing an interchangeable intermediate to an implant. Furthermore, the present invention relates to a prosthetic interchangeable intermediate for fixing a dental prosthesis to said base. The invention concerns a prosthetic component manufactured by additive manufacturing, which comprises: a base comprising a cavity with an internal thread; an interchangeable intermediate, said interchangeable intermediate comprising a through hole; and a screw configured to be inserted into the through hole of the interchangeable intermediate, wherein the base is permanently fixed to a dental implant by screwing the external thread of said base, and the interchangeable intermediate is fixed to the base by screwing the external thread of the screw into the internal thread of the base, such that a lower surface of the screw edge fits by interference against a second surface, thereby fixing the base, the interchangeable intermediate, and the screw. Furthermore, it is contemplated that the base, the interchangeable intermediate, and the screw are subjected to surface coating processes with carbon nanostructures, such as graphene, by means of an electrochemical process, which minimizes bacterial concentration, thereby reducing infections.

### FIELD OF INVENTION

The present invention belongs to the technological field of dentistry and relates to a prosthetic component comprising a fixed base for attaching an interchangeable intermediate body to said base.

Furthermore, the present invention relates to a fixed base and interchangeable intermediate prosthetic assembly for attaching a dental prosthesis to a dental implant.

### BACKGROUND OF THE INVENTION

In the field of implantology, prosthetic components are all connection parts used on dental implants in clinical procedures (impressions, transfers) or for installing prostheses on implants. The selection of such components is an important step in treatment planning, and they must always be perfectly adapted to the implant in a passive manner.

These components have various types and shapes, varying in function so as to accommodate different clinical cases and the different stages of the impression-taking process and prosthesis installation.

The selection of prosthetic components depends on the implant connection system, aesthetic needs, the patient's occlusion, whether the prosthesis is temporary or permanent, cemented or screwed, the mucosa, and the implant's inclination relative to the crown axis.

There are various types of component groups, including transfer components, intermediates, and cylinders. The cylinders and intermediates are always connected to the implant by means of screws, and the prosthetic crown may be retained or fixed either by screw retention or by cementation. These are connection components used on implants or on prosthetic intermediates during clinical impression-taking procedures and may have conical or round configurations (closed-tray), square configurations (open-tray), as well as transfer components (open-tray and closed-tray).

These are components installed directly on the implants to establish the connection between the prosthesis and the implant. They are also known as abutments, conical abutments, mini-abutments, connectors, and transmucosal.

The prosthesis can be fixed to the intermediate using screws or cementation. As examples we have: standard abutments, UCLA, zirconia abutments, conical and mini-conical abutments with or without angulation.

Document BR132019012807-0 discloses an intermediate dental prosthetic component, consisting of two parts that are joined by a screw thread, applicable especially for use in dental implant surgeries, in the zygomatic arch bone, inserted by screwing, through a surgical process in an intraoral procedure in a conventional implant surgically installed together with the anti-rotational prosthetic element.

Furthermore, document MU8800606 discloses a single-piece abutment provided with a Morse taper connection, which allows connection with the conical cavity of a dental implant.

This type of abutment with direct implant-prosthesis connection, widespread in the state of the art, although still useful today, requires the manufacture of different models of size, angle, and shape to meet different clinical cases. From the point of view of the production of these implants, it is necessary to adapt machinery so that different parts require different manufacturing processes. Furthermore, their shape must take into account whether the prosthesis will be screwed or cemented to the implant.

Furthermore, transfer components are state-of-the-art solutions for transferring the position and dimensions of dental implants and prosthetic intermediates (micro-abutments, mini-abutments, and abutments) to a laboratory model for subsequent fabrication of the prosthesis.

The transfer component must be perfectly adapted to the implant before taking the impression. A periapical radiograph can be used to verify this adaptation. Poor adaptation between the prosthesis and the abutment (intermediaries) leads to stress and overload on the implant screws.

Transfer components have a non-retentive design and are removed from the implants after impression taking to be fixed to the analog piece (analog) and subsequently inside the impression, being positioned as if it were in the mouth.

Document U.S. Pat. No. 6,290,499 discloses a set of dental impression components that may be used for impression-taking techniques, including an impression coping having an external surface with its lower end configured to reside below the gingiva surrounding the implant. Furthermore, a passage is provided through the impression coping that receives a first means for securing the impression coping to the implant for use in a pick-up type impression application.

Document WO 2020/075071 discloses a dental implant system provided with a truncated cone implant cavity; an abutment having an abutment pin of such size and shape that it is permanently retained in the truncated cone implant cavity and an abutment head suitable for supporting a dental crown; a dental transfer component with a transfer component pin intended to be inserted into the truncated cone implant cavity before an impression is taken and a transfer component head identical to the abutment head and an implant analog (having an analog internal cavity suitable for receiving the transfer component pin).

In implant-retained and mucosa-supported prostheses, for each intermediate there is a corresponding transfer component and cylinder for prosthesis fabrication. The choice of intermediates depends on local factors such as peri-implant gingival depth, gingival biotype, implant inclinations, intermaxillary space, single and multiple prostheses, implant position in the arch, and the type of prosthesis.

As can be seen, there are several devices for connecting a dental prosthesis to the implant intended to receive the prosthesis, so manufacturing different types of abutments or intermediates implies a high cost in logistics and manufacturing for different components.

Another important factor is that the prosthetic impression-taking process requires constant alternation between position-transfer devices and temporary and definitive abutments. This frequent replacement of components results in significant material loss and increases the risk of infection, since the internal threaded interface of the implant is exposed multiple times.

In this regard, document BR 11 2019 025239 8 reveals a base for a dental implant system that includes a long cavity that optionally extends below the top of the implant and a superstructure configured to be inserted into the cavity through a non-circular fitting. However, this fitting does not have an adequate seal, allowing the infiltration of bacteria that cause bad breath; furthermore, the base has a small size, which increases the load during masticatory effort, also requiring more effort from the fixation screw.

In order to solve these problems, the present invention provides a definitive universal base having curved walls with an angled straight portion, which dissipates masticatory load, said base being adapted to be coupled to the implant and having, in its coronal region, a connection for various prosthetic components, such that only the upper tip portion is replaced during prosthetic procedures, by means of a conical Morse taper fitting, which enhances sealing and prevents bacterial ingress at the interface. In this manner, a single model may be produced and its installation is definitive, such that the upper component varies according to the clinical case, the type of prosthesis fixation, and the intended purpose of the procedure.

Furthermore, the present invention comprises a design that allows for complete sealing of the prosthetic connection between the implant and the prosthetic component, achieved through additive manufacturing.

Furthermore, the present invention comprises coating the prosthetic component with carbon nanostructures by an electrochemical process with the incorporation of the nanostructures into the anodizing solution, conferring antimicrobial properties to the surface.

Therefore, there is no equivalent solution in the state of the art to that presented here in the present invention that combines, with an inventive construction, technical advantages, antimicrobial properties, practicality and quality.

### OBJECTIVES OF THE INVENTION

Thus, it is an objective of the present invention to provide a solution to the challenges and limitations listed above, presenting a base for a permanent prosthetic component that does not require replacement or removal during the impression-taking and fixation stages of the dental prosthesis.

Another objective of the present invention is to provide a universal base that can be adapted for different purposes and clinical cases by changing an interchangeable upper component.

It is also an objective of the present invention to provide interchangeable intermediate components for different purposes and clinical cases in order to adapt a universal dental abutment base.

It is also an objective of the present invention to provide a safe base-intermediate fitting with antimicrobial technology.

It is also an objective of the present invention to provide a base with angled and long walls that dissipate the loads of masticatory effort.

It is also an objective of the present invention to reconcile the ambitions of the present invention with contemporary manufacturing processes that offer high automation, precision, and flexibility through additive manufacturing.

It is a further object of the present invention to provide a base and intermediate system that reduces manufacturing costs when compared to the benefits of additive manufacturing versus conventional methods (machining, Computer Numerical Control, CNC), as well as reducing clinical procedure costs.

### BRIEF DESCRIPTION OF THE INVENTION

The present invention achieves these and other objectives by means of a basis comprising:
an apical end with an external thread, configured to be threaded into an internal thread of an implant;
an angled wall having a curved transition region, such that a diameter of the coronal end is greater than a diameter of a junction region between the angled wall and the transition region;
an internal cavity formed by an internal wall, located immediately below the surface of the coronal end;
a connecting region with a circular profile located immediately below the internal wall; and
an internal thread, located immediately below the connection area.

Furthermore, the present invention achieves these and other objectives by means of a screw configured to be inserted into the through hole of the interchangeable intermediate, said screw comprising:
a first exterior wall and a second exterior wall;
a second section delimited by the difference in diameter between the first exterior wall and a second exterior wall;
an edge at its coronal end, said edge having the same diameter as the upper surface of the interchangeable intermediate;
an external threa, configured to be threaded into the internal thread of the base; and
an upper internal thread.

Furthermore, the present invention achieves these and other objectives by means of an interchangeable intermediate comprising:
through hole;
said hole comprising a first internal wall and a second internal wall, wherein the second internal wall has a smaller diameter than the first internal wall;
said hole further comprising a first section delimited by the difference in diameter between the first internal wall and the second internal wall;
an apical end with a dodecagonal profile (12 sides);
a connection region adjacent to said apical end; and configured to connect to the base connection region;
an edge of the same diameter as the surface of the coronal end of the base; wherein said interchangeable intermediate is configured to be fixed to a dental prosthesis.

Furthermore, the present invention achieves these and other objectives by means of a prosthetic component for attaching a dental prosthesis to a dental implant comprising:
a base, said base comprising;
an apical end with an external thread, configured to be threaded into an internal thread of said implant;
an angled wall, with a curved transition region, such that the diameter of the coronal end is greater than the diameter of the junction region between the angled wall and the transition region;
an internal cavity formed by an internal wall, located immediately below the surface of the coronal end;
a connecting region with a hexagonal profile located immediately below the internal wall; and
an internal thread, located immediately below the connection area;

an interchangeable intermediary, said interchangeable intermediary comprising:
through hole;
said hole comprising a first internal wall and a second internal wall, wherein the second internal wall has a smaller diameter than the first internal wall;
said hole further comprising a first section delimited by the difference in diameter between the first internal wall and the second internal wall;
an apical End With a Dodecagonal Profile (12 Sides);
a connection region adjacent to said apical end, configured to connect to the base connection region;
an edge of the same diameter as the surface of the coronal end of the base; and
a prosthesis-fixing wall defining an annular upper surface;
the prosthetic attachment wall being configured to be attached to a dental prosthesis;

a screw configured to be inserted into the through hole of the interchangeable intermediate, said screw comprising:
a first exterior wall and a second exterior wall;
a second section delimited by the difference in diameter between the first outer wall and a second external wall;
an edge at its coronal end, said edge having the same diameter as the upper surface of the interchangeable intermediate;
an external thread, configured to be threaded into the internal thread of the base; and
an upper internal thread.

Wherein the base is definitively fixed to a dental implant by fixation of the external thread of said base, and the interchangeable intermediate is fixed to the base by fixation of the external thread of the screw with the internal thread of the base, such that a lower surface of the edge of the screw fits by interference against the second surface, thereby securing the base, the interchangeable intermediate, and the screw.

### BRIEF DESCRIPTION OF THE DRAWINGS

The present invention will be described based on the attached drawings, which illustrate:

FIG. 1 represents an exploded perspective view of a prosthetic component consisting of a base, an interchangeable intermediate and a screw, according to a preferred embodiment of the present invention;

FIG. 2 represents a perspective view of a base according to a preferred embodiment of the present invention;

FIG. 3 represents the front view of the base according to a preferred embodiment of the present invention;

FIG. 4 represents a sectional view of a base according to a preferred embodiment of the present invention;

FIG. 5 represents a sectional view of an interchangeable intermediate-screw engagement according to features common to all embodiments of the interchangeable intermediate of the present invention;

FIG. 6 represents the front view of an interchangeable intermediate according to the characteristics common to all embodiments of interchangeable intermediates of the present invention;

FIG. 7 represents a perspective view of a screw according to a preferred embodiment of the present invention;

FIG. 8 represents the front view of a screw according to a preferred embodiment of the present invention;

FIG. 9 represents a front view of an interchangeable intermediate-screw engagement according to a first preferred embodiment of the present invention;

FIG. 10 represents a perspective view of an interchangeable intermediate according to a first preferred embodiment of the present invention;

FIG. 11 represents a perspective view of the complete prosthetic component according to a first preferred embodiment of the present invention;

FIG. 12 represents a perspective view of an interchangeable intermediate according to a second preferred embodiment of the present invention;

FIG. 13 represents a perspective view of the complete prosthetic component according to a second preferred embodiment of the present invention;

FIG. 14 represents a perspective view of an interchangeable intermediate according to a preferred third embodiment of the present invention;

FIG. 15 represents a perspective view of the complete prosthetic component according to a third preferred embodiment of the present invention;

FIG. 16 represents a perspective view of an interchangeable intermediate according to a fourth preferred embodiment of the present invention;

FIG. 17 represents a perspective view of the complete prosthetic component according to a fourth preferred embodiment of the present invention;

FIG. 18 represents a perspective view of an interchangeable intermediate according to a fifth preferred embodiment of the present invention;

FIG. 19 represents a perspective view of the complete prosthetic component according to a fifth preferred embodiment of the present invention;

FIG. 20 represents a perspective view of an interchangeable intermediate according to a sixth preferred embodiment of the present invention;

FIG. 21 represents a perspective view of the complete prosthetic component according to a sixth preferred embodiment of the present invention;

FIG. 22 represents a perspective view of an interchangeable intermediate according to a seventh preferred embodiment of the present invention;

FIG. 23 represents a perspective view of the complete prosthetic component according to a seventh preferred embodiment of the present invention;

FIG. 24 represents a perspective view of an interchangeable intermediate according to an eighth preferred embodiment of the present invention;

FIG. 25 represents a perspective view of the complete prosthetic component according to an eighth preferred embodiment of the present invention;

FIG. 26 represents a sectional view of the complete prosthetic component according to a preferred embodiment of the present invention.

### DETAILED DESCRIPTION OF THE INVENTION

The present invention relates to a prosthetic connection component composed of a universal base for fixing an interchangeable intermediate to an implant, and a prosthetic interchangeable intermediate for fixing a dental prosthesis to the base.

The present invention offers numerous technical and economic advantages when compared to the state of the art, some of which are listed below:
The present invention constitutes a first fixed construction, which eliminates the need to remove the intermediate during the impression-taking and prosthesis fixation stages;
The present invention presents a prosthetic component with a surface coated with carbon structures such as graphene, carbon nanostructures through an electrochemical process, which minimizes the concentration of bacteria, reducing infections;
The present invention features an interchangeable intermediate that allows the base to be used for various clinical settings and different purposes;
The present invention offers greater sealing power between the base and the intermediate, preventing the infiltration of bacteria that cause bad breath, while providing greater stability to the dental prosthesis;
The present invention presents a solution made by additive manufacturing of the fixed base in said intermediate with high quality and reliability;
The present invention provides greater load dissipation during masticatory effort, requiring less effort from the fastening screw during masticatory force.

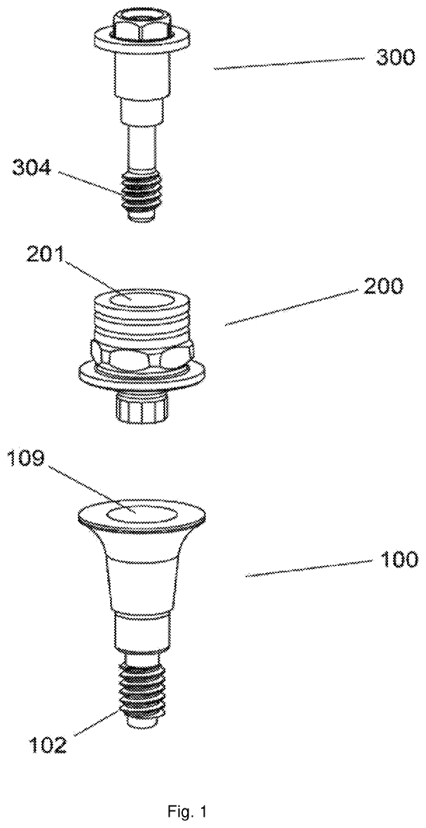

The present invention comprises a prosthetic component for prosthesis fixation and a multicomponent solution. In a preferred embodiment of the present invention, as shown in FIG. 1, the prosthetic component comprises a base 100, an interchangeable intermediate 200 and a screw 300.

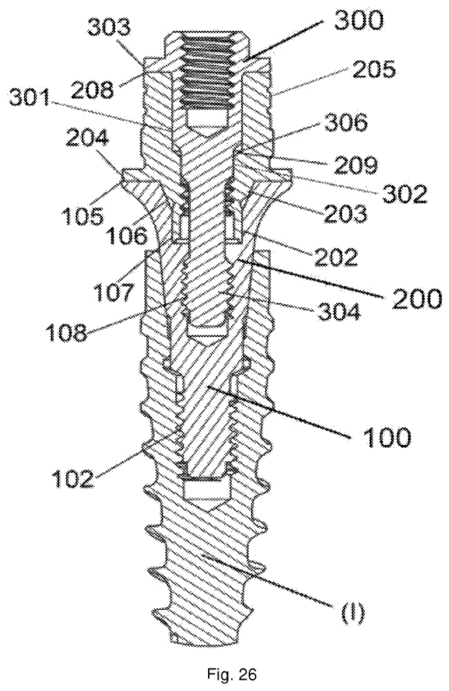

With reference to FIG. 26, the base 100 is configured to fix an interchangeable intermediate 200 to a user's implant 1 by means of a screw 300.

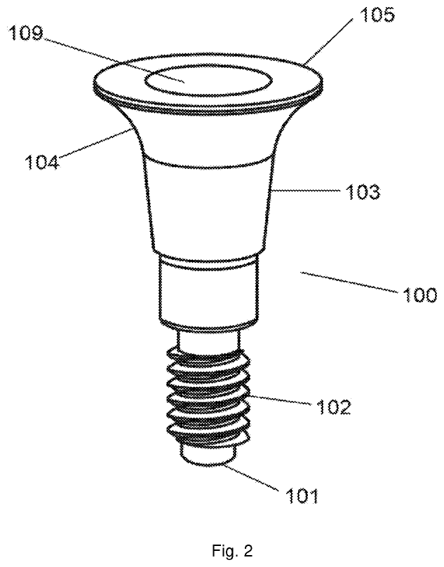

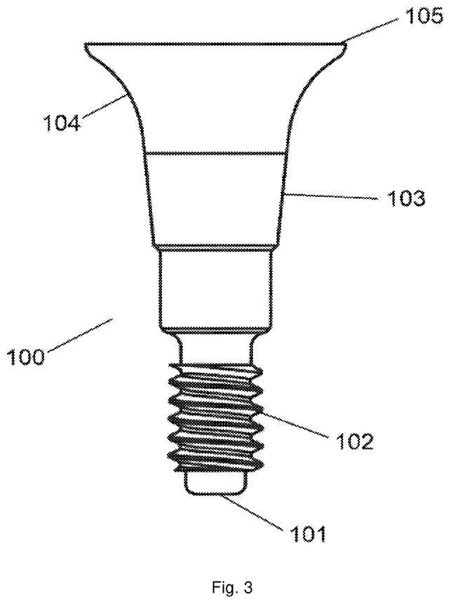

Referring to FIGS. 2 and 3, the base 100 comprises an apical end 101 with an external thread 102, configured to be screwed into an internal thread of an implant. The base 100 has an angled wall 103, with a curved transition region 104, such that the diameter of the coronal end 105 is greater than the diameter of the junction region between the angled wall 103 and the transition region 104.

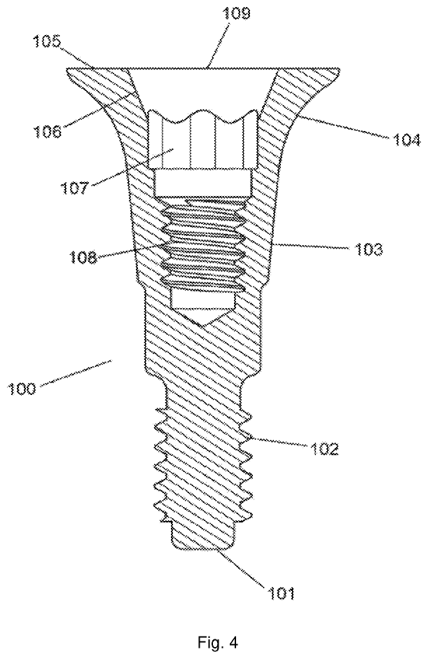

The base 100 comprises an internal cavity formed by an internal wall 106, located immediately below the coronal end surface 105, a connection region 107 located immediately below the internal wall 106 and an internal thread 108, located immediately below the connection region 107 as shown in FIG. 4.

Preferably, the internal wall 106 is angled between 5° and 60°, defining a circular conical profile.

Furthermore, connection region 107 has a hexagonal profile for Morse taper connection.

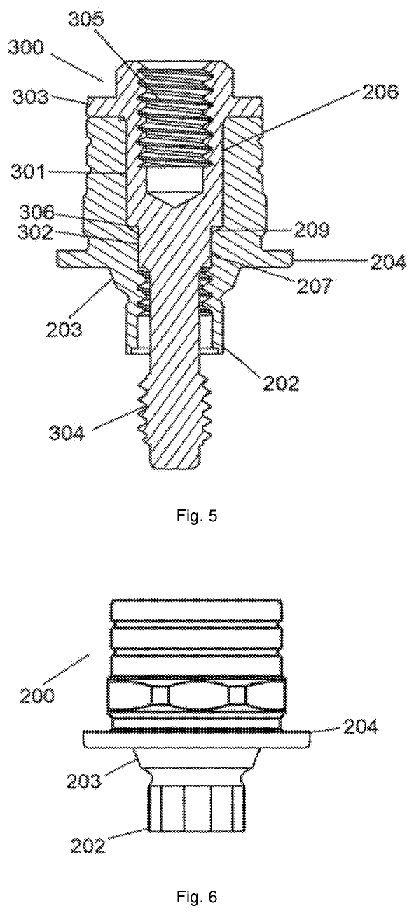

With reference to FIGS. 5 and 6, the interchangeable intermediate 200 comprises a hollow construction with a through hole 201 (shown in FIG. 1). In a preferred embodiment, the interchangeable intermediate comprises an apical end 202 with a dodecagon profile (12 sides), adjacent to a connection region 203 configured to connect to the connection region 107 (shown in FIG. 26) of the base 100 (shown in FIG. 26) and an edge 204 of the same diameter as the surface of the coronal end 105 (shown in FIG. 26).

The hole 201 (shown in FIG. 1) of the interchangeable intermediate 200 comprises a first internal wall 206 and a second internal wall 207, the second internal wall 207 having a smaller diameter than the first internal wall 206, as referenced in FIG. 5. The interchangeable intermediate further comprises a first section 209 delimited by the difference in diameter between the first internal wall 206 and the second internal wall 207.

Additionally, the base 100 is configured to receive different types of interchangeable intermediates 200, such that the interchangeable intermediate 200 has smaller dimensions than a complete abutment (state of the art), making it possible to facilitate the exchange of this intermediate component as needed for the use of different intermediates throughout a surgical treatment, saving a large amount of material, since only the intermediate component is changed.

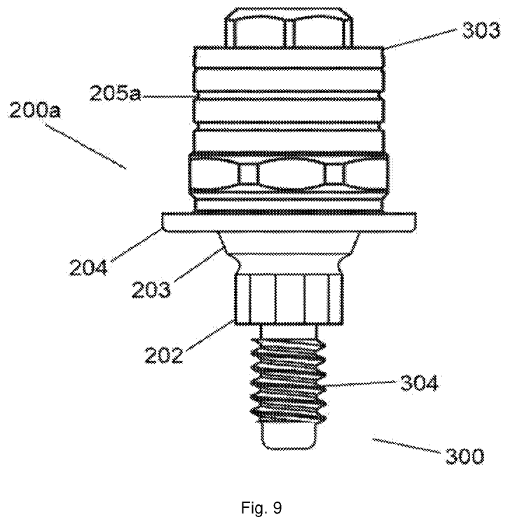

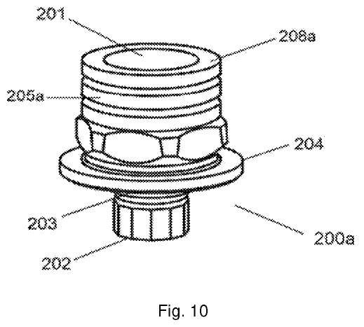

Furthermore, according to FIGS. 9 to 11, the interchangeable intermediate 200 is configured to be used as an abutment 200a. The interchangeable intermediate abutment 200a comprises a prosthetic attachment wall 205a. The prosthetic attachment wall 205a is configured to be attached to a dental prosthesis by cementation or attachment. Said prosthetic attachment wall 205a describes a superior surface 208a. In a preferred embodiment, the interchangeable intermediate 200 has a diameter between 2.5 mm and 6 mm at its apical end 202, while the length of the coronal portion (prosthetic attachment wall 205a) comprises between 2 to 12 millimeters.

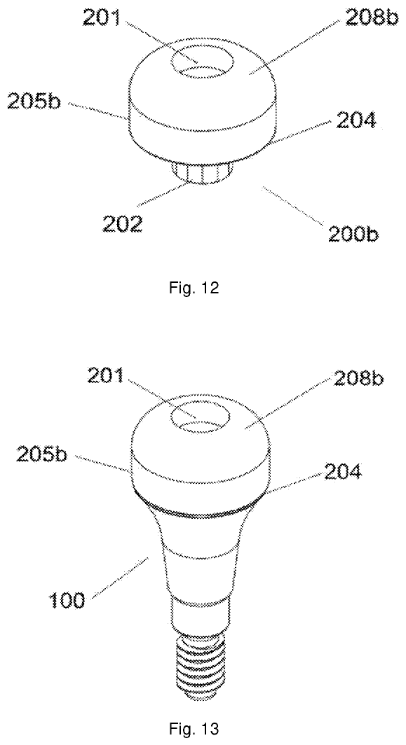

Referring to FIGS. 12 and 13, the interchangeable intermediate 200 is illustrated according to a second embodiment, in which it is configured to be used as a healing abutment 200b. The interchangeable intermediate healing abutment 200b comprises a straight transitional wall 205b and a polished and rounded healing surface 208b. The interchangeable intermediate 200b is configured to be fixed to the base 100 during a healing period after implantation and to be removed after this period to be replaced by a definitive abutment or a transfer component, without the need to remove the base 100.

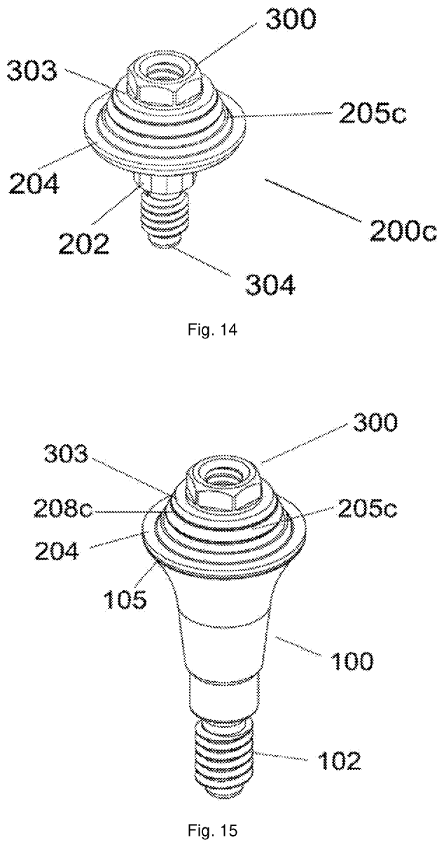

Referring to FIGS. 14 and 15, the interchangeable intermediate 200 is illustrated according to a third embodiment, in which it is configured to be used as a mini abutment 200c. The interchangeable intermediate mini abutment 200c comprises a prosthetic attachment wall 205c that describes an annular upper surface 208c. The prosthetic attachment wall 205c is configured to be fixed to a dental prosthesis, by cementation or attachment, in cases of reduced interocclusal distance that would hinder the installation of a normal-sized interchangeable intermediate abutment 200a.

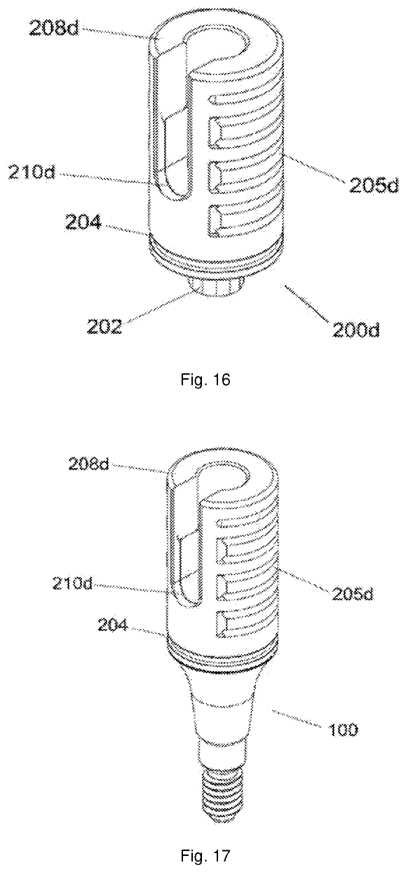

With reference to FIGS. 16 and 17, the interchangeable abutment 200 is illustrated according to a fourth embodiment, in which it is configured to be used as a provisional or definitive abutment with a UCLA model (depending on the raw material used) 200d. The interchangeable intermediate 200d comprises a support body for the prosthesis 205d, an internal fixation region 210d configured to fix a dental prosthesis by direct threading of the prosthesis through the interchangeable intermediate 200d into the base 100.

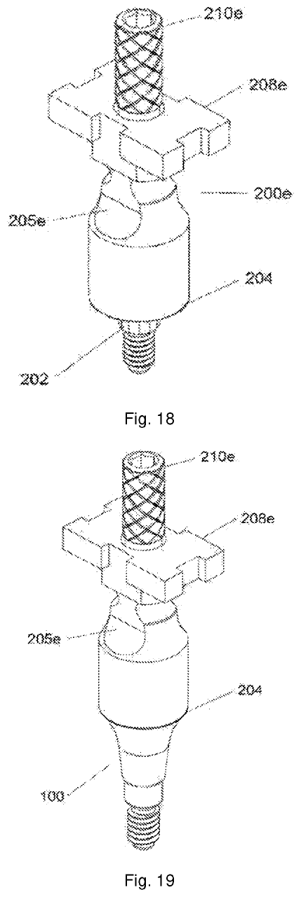

Referring to FIGS. 18 and 19, the interchangeable intermediate 200 is illustrated according to a fifth embodiment, in which it is configured to be used as a transfer abutment 200e. In this embodiment, the interchangeable intermediate 200e is configured to be fixed to the base 100 by means of a fixing thread 210e, for making an impression of the patient's mouth, and comprises an impression fixation wall 205e and an impression anchorage region 208e. In this way, it is possible to make an impression of the patient's gingiva and teeth and then exchange it for a definitive prosthesis abutment or fixation abutment, without the need to remove the base 100 from the implant.

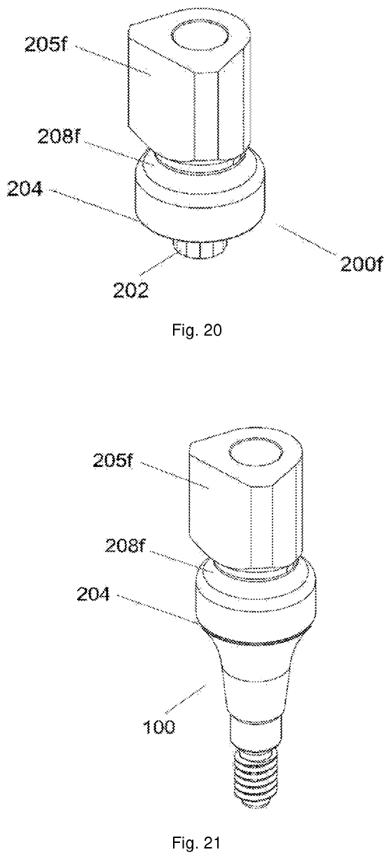

Referring to FIGS. 20 and 21, the interchangeable intermediate 200 is illustrated according to a sixth embodiment, in which it is configured to be used as a scanbody 200f. The scanbody 200f comprises a main structure 205f and a transition region 208f and is configured to be fixed to the base 100 and transmit data related to the angulation and position of seated implants. The data can be collected with a desktop digital scanner or an intraoral scanner and is extremely accurate. In this way, it is possible to perform the scan with the scanbody 200f and interchange it to a prosthesis abutment or fixation intermediate without the need to remove the base 100 from the implant.

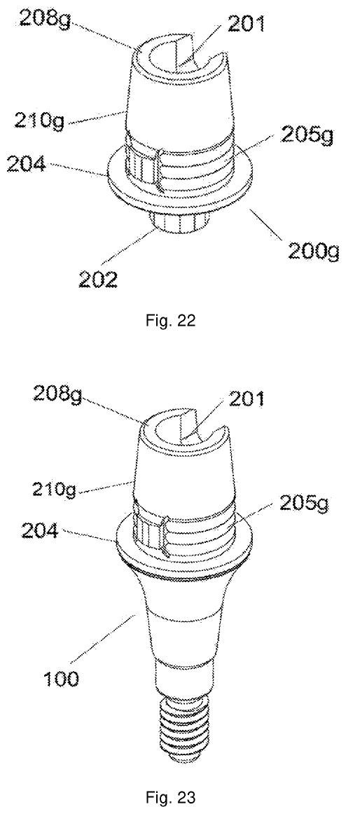

Referring to FIGS. 22 and 23, the interchangeable intermediate 200 is illustrated according to a seventh embodiment, in which it is configured to be used as a tiBase 200g. The tiBase 200g intermediate comprises a precision-fitting wall 205g that transitions into a smooth wall 210g so that it describes an upper region 208g, and is configured to fix a dental prosthesis by cementation and a fit between the precision-fitting wall 205g and the CAD/CAM modeled prosthesis to fit precisely into the engagement 205g.

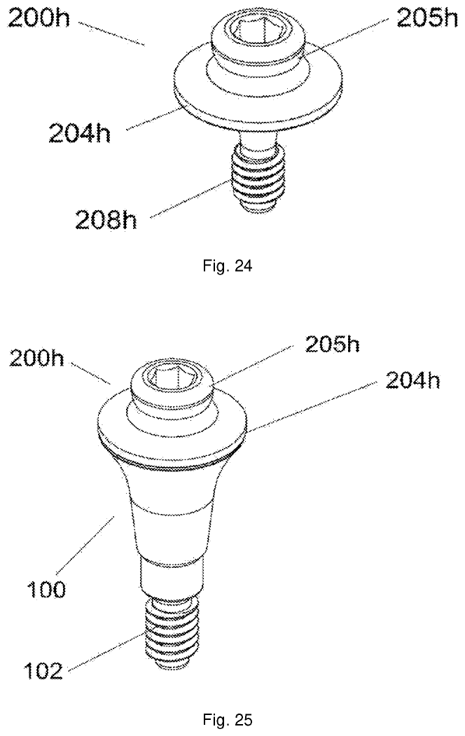

With reference to FIGS. 24 and 25, the interchangeable intermediate 200 is illustrated according to an eighth embodiment, in which it is configured so as to be used as an equator system 200h. The equator 200h comprises a denture fixing region 205h and a thread 208h and is configured to fix at least one denture fixing point and is threaded directly onto the base 100 without the need for a screw.

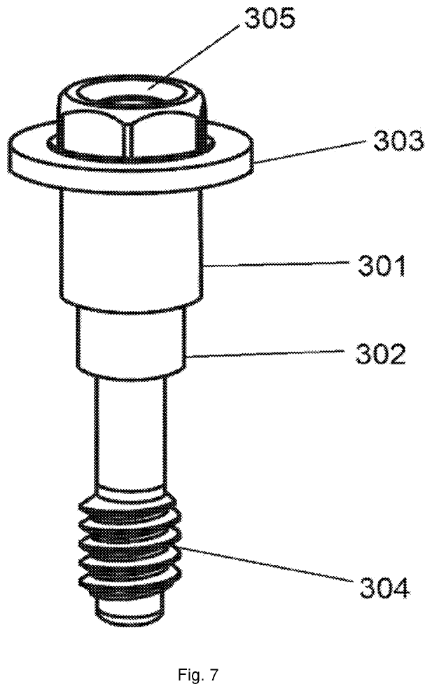

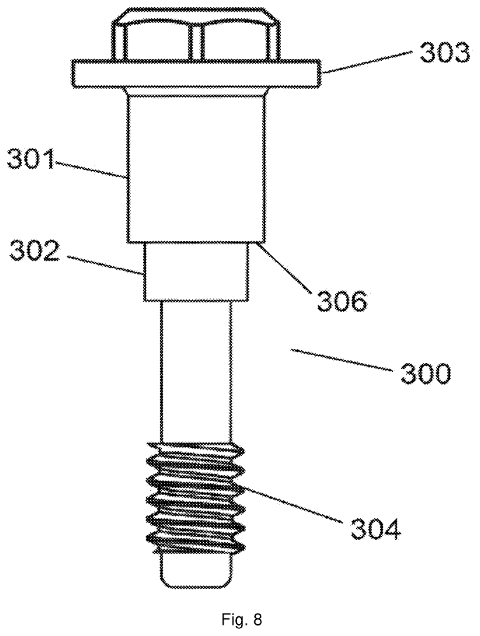

With reference to FIGS. 7 and 8, the present invention further comprises a screw 300, having a first external wall 301 and a second external wall 302, configured to be inserted into the through hole 201 (shown in FIG. 1) of the interchangeable intermediate 200 (shown in FIG. 1).

The screw 300 further comprises a screw rim 303 at its coronal end, said screw rim 303 having the same diameter as the upper surface 208 of the interchangeable intermediate (as illustrated in FIG. 26), and an external thread 304, configured to be threaded into the internal thread 108 of the base 100 (as illustrated in FIG. 26).

The screw 300 further comprises an upper internal thread 305 configured to provide additional fixation for different types of dental prostheses.

Additionally, base 100 can preferably be made by additive manufacturing, such as 3D printing via Laser Metal Fusion (LMF), Stereolithography (SLA), Digital Light Processing (OLP), Selective Laser Sintering (SLS), and Selective Laser Melting (SLM).

### How the Device Works

An initial fixation is achieved by threading the external thread 102 of the base 100 onto the thread of the internal surface of a dental implant.

In the first stage of treatment, the base 100 is permanently installed on the implant, so that the interchangeable intermediate 200 is changed according to the stage of treatment. Part of the angled wall 103 and the transition region 104 provide a continuous surface in contact with the patient's gum, which minimizes the accumulation of bacteria in this region.

Referring to FIG. 26, the interchangeable intermediate 200 is fixed to the base 100 by fixing the external thread 304 of the screw 300 to the internal thread 108. The difference in diameter between the first external wall 301 and a second external wall 302 defines a second section 306.

Furthermore, the difference in diameter between the first internal wall 206 and the second internal wall 207 defines a first section 209, as referenced in FIG. 5.

Upon screwing the screw 300 into the base 100, the screw rim 303 fits by interference against the upper surface 208 of the interchangeable intermediate 200, thereby securing the base 100, the interchangeable intermediate 200, and the screw 300, as shown in FIG. 26.

Furthermore, the connection region 203 of the intermediate 200 performs a Morse taper connection with the connection region 107 of the base, sealing the inner part of the base 100.

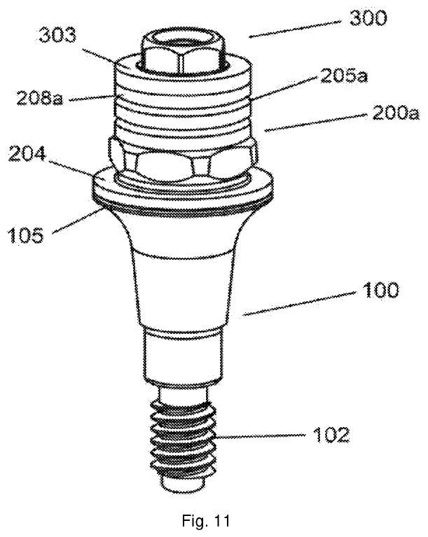

When fixed, the edge of the intermediate 204 is juxtaposed in relation to the coronal end 105 of the base 100, preventing the accumulation of debris and bacteria at the base-intermediate interface due to the property of the Morse taper type connection that allows a cold solder joint, as illustrated in FIGS. 11 and 26.

Similarly, the screw rim 303 is positioned in abutting relation to the upper surface 208 of the intermediate 200, thereby preventing the accumulation of debris and bacteria at the intermediate-screw interface.

It is anticipated that interchangeable intermediate 200 can be a definitive prosthetic component.

It is anticipated that interchangeable intermediate 200 may be a temporary prosthetic component.

It is anticipated that interchangeable intermediate 200 can be a component with the upper end of a transfer device.

The present invention revolutionizes by providing a definitive installation base 100, such that the interchangeable intermediate 200 has smaller dimensions than a complete abutment (state of the art), so that the use of different intermediates 200 throughout a surgical treatment saves a large amount of material, since only the interchangeable intermediate 200 is changed.

Because of this, the movement of the thread 102 of the base 100 on the implant only occurs once, and therefore there is no wear on the internal surface of the implant, nor on the base-implant interface.

The use of multiple intermediates may generate gaps and rough and/or striated surfaces at the intermediate junctions, which would result in increased accumulation of organic debris, food, blood, and the like, thereby presenting a high risk of bacterial accumulation in the region.

With this in mind, the unique construction of the present invention features extremely close-fitting interfaces, achieved through the juxtaposition of the intermediate edge 204 in relation to the coronal end 105 of the base 100 and the juxtaposition of the screw rim 303 in relation to the upper surface 208 of the intermediate 200.

Furthermore, the conical circular Morse taper profile of the connection region 107 and the connection region 203 form an anti-rotation interface between the base 100 and the interchangeable intermediate 200.

Furthermore, it is anticipated that base 100, interchangeable intermediate 200, and screw 300 will undergo coating processes with carbon nanostructures such as graphene through an electrochemical process, which minimizes the concentration of bacteria, thus reducing infections.

Having described some examples of preferred embodiments of the present invention, it should be understood that the scope of the present invention encompasses other possible variations of the inventive concept described, being limited only by the content of the claims alone, including possible equivalents.

1. Base (100), characterized in that it comprises:
an apical end (101) having an external thread (102), configured to be threaded into an internal thread of an implant;
an angled wall (103), with a curved transition region (104), such that the diameter of the coronal end (105) is greater than the diameter of the junction region between the angled wall (103) and the transition region (104);
an internal cavity formed by an internal wall (106), located immediately below the surface of the coronal end (105);
a connection region (107) located immediately below the internal wall (106); and
an internal thread (108), located immediately below the connection region (107).

2. Screw (300), characterized in that it comprises:
a first external wall (301) and a second external wall (302);
a second section (306) defined by the difference in diameter between the first external wall (301) and the second external wall (302);
a screw rim (303) at its coronal end, said screw rim (303) having the same diameter as the upper surface (208) of the interchangeable intermediate component;
an external thread (304), configured to be screwed into the internal thread (108) of the base (100); and
an upper internal thread (305).

3. Interchangeable intermediate (200), characterized in that it comprises:
a through hole (201);
said through hole (201) comprising a first internal wall (206) and a second internal wall (207), the second internal wall (207) having a smaller diameter than the first internal wall (206);
said through hole (201) further comprising a first section (209) defined by the difference in diameter between the first internal wall (206) and the second internal wall (207);
an apical end (202) having a dodecagonal profile;
a connection region (203) adjacent to said apical end (202), configured to connect to a of a base (100); and an edge (204) having the same diameter as the surface of the coronal end (105) of the base (100) .

4. Interchangeable intermediate (200) according to claim 3, characterized in that it is configured as an intermediate abutment component (200a), further comprising:
a prosthesis fixation wall (205a) defining an annular upper surface (208a);
said prosthesis fixation wall (205a) being configured to be fixed to a dental prosthesis.

5. Interchangeable intermediate (200) according to claim 3, characterized in that it is configured as a healing intermediate component (200b), further comprising:
a straight transitional wall (205b); and
a polished and rounded healing surface (208b);
wherein the interchangeable healing intermediate component (200b) is configured to be fixed to the base (100) during a healing period.

6. Interchangeable intermediate (200) according to claim 3, characterized in that it is configured as a mini-abutment intermediate component (200c), further comprising:
a prosthesis fixation wall (205c) defining an annular upper surface (208c);
said prosthesis fixation wall (205c) being configured to be fixed to a dental prosthesis in cases of reduced interocclusal distance.

7. Interchangeable intermediate (200) according to claim 3, characterized in that it is configured as a provisional or definitive UCLA-type intermediate component (depending on the raw material employed) (200d), further comprising:
a prosthesis support body (205d) defining an upper surface (208d);
an internal fixation region (210d);
wherein the prosthesis support body (205d) and the internal fixation region (210d) are configured to fix a dental prosthesis and allow direct screwing of said prosthesis.

8. Interchangeable intermediate (200) according to claim 3, characterized in that it is configured as a transfer intermediate component (200e), further comprising:
an impression fixation wall (205e); and
an impression anchoring region (208e);
wherein said interchangeable transfer intermediate component (200e) is configured to be fixed to the base (100) by means of a fixation screw (210e), for taking a dental impression of a patient's mouth.

9. Interchangeable intermediate (200) according to claim 3, characterized in that it is configured as a scanbody intermediate component (200f), further comprising:
a main structure (205f); and
a transition region (208f);
wherein said interchangeable scanbody intermediate component (200f) is configured to be fixed to the base (100) and to transmit data related to the angulation and position of seated implants.

10. Interchangeable intermediate (200) according to claim 3, characterized in that it is configured as a tiBase intermediate component (200g), further comprising:
a precision-fit wall (205g) transitioning to a smooth wall (210g), thereby defining an upper region (208g);
wherein said interchangeable tiBase intermediate component (200g) is configured to fix a dental prosthesis by cementation and by a fitting engagement between the precision-fit wall (205g) and a CAD/CAM-modeled prosthesis configured to precisely fit onto said precision-fit wall (205g), with the base (100) being previously fixed to a dental implant.

11. Interchangeable intermediate (200) according to claim 3, characterized in that it is configured as an equator intermediate component (200h) for denture fixation, further comprising:
a transition (208h); and
a denture fixation region (205h);
wherein it is configured to fix at least one denture retention bridge and is directly threaded into the base (100).

12. Prosthetic component for fixing a dental prosthesis to a dental implant, characterized in that it comprises:
a base (100), said base (100) comprising:
an apical end (101) having an external thread (102), configured to be screwed into an internal thread of said implant;
an angled wall (103), with a curved transition region (104), such that the diameter of the coronal end (105) is greater than the diameter of the junction region between the angled wall (103) and the transition region (104);
an internal cavity (109) formed by an internal wall (106), located immediately below the surface of the coronal end (105);
a connection region (107) having a hexagonal profile, located immediately below the internal wall (106); and
an internal thread (108), located immediately below the connection region (107);
an interchangeable intermediate (200), said interchangeable intermediate (200) comprising:
a through hole (201);
said through hole (201) comprising a first internal wall (206) and a second internal wall (207), the second internal wall (207) having a smaller diameter than the first internal wall (206) ;
said through hole (201) further comprising a first section (209) defined by the difference in diameter between the first internal wall (206) and the second internal wall (207);
an apical end (202) having a dodecagonal profile (12 sides);
a connection region (203) adjacent to said apical end (202), configured to connect to the connection region (107) of the base (100);
an edge (204) having the same diameter as the surface of the coronal end (105) of the base (100);
wherein said interchangeable intermediate (200) is configured to be fixed to a dental prosthesis; and
a screw (300) configured to be inserted into the through hole (201) of the interchangeable intermediate (200), said screw (300) comprising:
a first external wall (301) and a second external wall (302);
a second section (306) defined by the difference in diameter between the first external wall (301) and the second external wall (302);
a screw rim (303) at its coronal end, said screw rim (303) having the same diameter as the upper surface (208) of the interchangeable intermediate component;
an external thread (304), configured to be screwed into the internal thread (108) of the base (100) ; and
an upper internal thread (305);
wherein the base (100) is permanently fixed to a dental implant (1) by screwing the external thread (102) of said base (100), and the interchangeable intermediate (200) is fixed to the base (100) by screwing the external thread (304) of the screw (300) into the internal thread (108) of the base, such that a lower surface of the screw rim (303) interferentially fits against the upper surface (208), thereby fixing the base (100), the interchangeable intermediate (200), and the screw (300).

13. Prosthetic component according to claim 12, characterized in that the base (100) is configured to receive at least one interchangeable intermediate component selected from:
abutment (200a), healing component (200b), mini-abutment (200c), provisional or UCLA component (200d), transfer component (200e), scanbody component (200f), tiBase component (200g), and equator component (200h).

14. Prosthetic component according to claim 12 characterized in that the edge of the intermediate component (204) is positioned in abutting relationship with the coronal end (105) of the base (100), thereby sealing the base-intermediate interface.

15. Prosthetic component according to claim 12 characterized in that the screw rim (303) is positioned in abutting relationship with the upper surface (208) of the intermediate (200), thereby sealing the intermediate-screw interface.

16. Prosthetic component according to claim 15, characterized in that, additionally, the internal wall (106) of the base (100) and the connection region (203) of the interchangeable intermediate (200) perform a Cone Morse taper connection, thereby sealing the intermediate-screw interface.

17. Prosthetic component according to claim 12 characterized in that the fixation of the dental prosthesis to the interchangeable intermediate (200) is performed by a method selected from: cementation, interference fit, and threading.

18. Prosthetic component according to claim 12 characterized in that the connection region (203) of the intermediate (200) performs a Cone Morse taper connection with the connection region (107) of the base, thereby sealing an internal portion of the base (100).

19. Prosthetic component according to claim 12 characterized in that the angled wall (103) and the transition region (104) form a continuous surface in contact with a user's gingiva.

20. Prosthetic component according to claim 12 characterized in that, preferably, the internal wall (106) is angled between 5° and 60°, defining a circular conical profile.

21. Prosthetic component according to claim 12 characterized in that the base (100) and the interchangeable intermediate (200) are preferably manufactured by additive manufacturing, preferably selected from:
3D impression by laser metal fusion (LMF),
stereolithography (SLA),
digital light processing (DLP),
selective laser sintering (SLS), and
elective laser melting (SLM).

22. Prosthetic component according to claim 21, characterized in that the base (100) is subjected to a surface coating process with carbon nanostructures.
